(19) United States
(12) Patent Application Publication
(10) Pub. No.: US 2024/0425118 A1
(43) Pub. Date: Dec. 26, 2024

(54) Apparatus for Enabling a Pod to be moved out of a Vehicle

(71) Applicant: Ho Keung TSE, Hong Kong (HK)

(72) Inventor: Ho Keung TSE, Hong Kong (HK)

(21) Appl. No.: 18/789,576

(22) Filed: Jul. 30, 2024

Related U.S. Application Data
(63) Continuation-in-part of application No. 17/578,487, filed on Jan. 19, 2022, now abandoned.
Application No. 17/578,487 is a continuation-in-part of application No. 17/426,102, filed on Jul. 28, 2021, now abandoned.

(30) Foreign Application Priority Data
Mar. 1, 2021 (WO) PCT/IB2021/051670
Dec. 5, 2021 (GB) 2117562.5
Dec. 29, 2021 (GB) 2119056.6
Jan. 15, 2022 (GB) 2200492.3

(51) Int. Cl. B62D 24/00; B60B 35/10

(52) U.S. Cl. CPC B62D 24/00; B60B 35/10

(57) ABSTRACT

A vehicle with a pod detachably secured to a chassis thereof, when in hazard escaping or transferring the pod to another platform, a control system will cause the pod to be detached from the chassis, and causing wheels to be moved out of wheel recesses of the pod, so as to provide some freedom for the pod to be moved laterally, by a side impact, or to enable the pod to be moved on the chassis partly or completely out of the vehicle longitudinally.

### CROSS-REFERENCE TO RELATED APPLICATIONS

This application is a continuation-in-part of U.S. patent application Ser. No. 17/578,487, filed on Jan. 19, 2022, which is a continuation-in-part of U.S. patent application Ser. No. 17/426,102, filed on Jul. 28, 2021, which is derived from PCT International application PCT/IB2020/061837, filed on Dec. 11, 2020.

U.S. patent application Ser. No. 17/578,487 claims priority to another PCT International application PCT/IB2021/051670 filed on Mar. 1, 2021, and this application is related to this another PCT application on the grounds that they contain common subject matter.

This application is related to U.S. patent application Ser. No. 15/929,449, filed on May 4, 2020, now U.S. Pat. No. 11,254,272 B2, on the grounds that they contain common subject matter, and both PCT International application PCT/IB2020/061837 and PCT/IB2021/051670 claim priority thereto.

All the patent applications from which this application claims priority benefit directly or indirectly, their entire contents are incorporated herein by reference (herein below they are collectively referred as “patent applications”).

### FEDERALLY SPONSORED RESEARCH AND DEVELOPMENT

Not Applicable

### JOINT RESEARCH AGREEMENT

Not Applicable

### REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### STATEMENT REGARDING PRIOR DISCLOSURES BY THE INVENTOR OR A JOINT INVENTOR

Not Applicable

### BACKGROUND OF THE INVENTION

### 1. Field of the Invention

The present invention relates to a vehicle with a separable pod, and particularly, relates to an apparatus for enabling the pod to be moved into or out of the vehicle, to escape from a hazard such as a collision or a fire, or in a pod transfer for transferring the pod between two platforms, which may be two different vehicles.

### 2. Description of Related Art of the Invention

Conventionally, passengers in a vehicle are protected by airbags in a collision, however, serious injuries can still happen.

And, in the recent years, vehicles with their individual chassis separable from a pod (alternatively called as a cabin) therein are proposed by different automobile manufacturers.

U.S. Pat. No. 8,041,483 and China utility model patent CN205971195U disclose using airbags to protect a vehicle and a cabin separated from a chassis, corresponding respectively, and their manners of protection are depending on the severity of an anticipated impact. The latter patent, in particular, discloses ejecting the cabin out of the vehicle.

### SUMMARY OF THE INVENTION

The present invention provides a vehicle with a separable pod. The pod can be moved longitudinally and laterally on the surface of a chassis of the vehicle, and not be hindered by the wheels, by moving the wheels out of the wheel recesses of pod.

Desirably, the surface of the chassis is planar, otherwise, inflatable airbags or the likes may be disposed on the bottom of the pod, to facilitate movement of the pod on the chassis.

### BRIEF DESCRIPTION OF DRAWINGS

FIG. 1 is a schematic diagram of an exemplified vehicle 1 with a separable pod 2 on a surface of chassis 3.

FIG. 2 is a schematic diagram of top view of an exemplified vehicle 1, when its wheels 4 are inside their corresponding respectively wheel-receiving recesses 5 of pod 2.

FIG. 3 is a schematic diagram of top view of an exemplified vehicle 1, when its wheels 4 are being moved out of their recesses 5 of pod 2, by extension of telescopic shafts 6.

Note that the above figures may not be in proportional, and in FIG. 1, the gaps between different parts therein, for instance, the pod and the chassis, are greatly exaggerated to avoid confusion, and in real practice, such gaps may exist but should be negligible.

### DETAILED DESCRIPTION OF THE INVENTION

According to the present invention and referring to FIG. 1, the present vehicle 1 may be capable of autonomous driving, or driven by a human inside or remotely. The pod 2 is detachably secured to chassis 3, and may be used for carrying goods, and/or humans.

In this document, all operable units of the present vehicle 1 are under control of a control system.

For instance, in a hazard escaping operation, the control system receives signals from some operable units which are hazard detectors such as, radars, cameras, fire/shock/impact sensor etc., as disclosed in the “patent applications”, and basing on the received signals, determines whether a hazard happens or going to happen, and makes decisions as to what operations should be performed, and finally, sends signals to some other operable units for causing them to perform the operations.

The detectors may provide information indicative of the severity of a hazard, to the control system.

When in a pod transfer, or when a hazard, or an imminent hazard, is detected by the detectors, the control system, in the latter cases may be dependent on the severity of the detected hazard, sends a signal to an attachment and detachment device, to cause it to detach pod 2 from chassis 3, for allowing relative movement between pod 2 and chassis 3, on the surface of chassis 3.

The attachment and detachment device may be an electromechanical lock.

A conventional detector, under control of the control system, includes an infra-red (IR) emitter and sensor for detecting if a locking pin of the attachment and detachment device, used for locking pod 2 with chassis 3, is in a locking (or unlocking) position, and if it is, it will block (or unblock) the IR communications between the emitter and sensor, and causing a corresponding signal to be sent to the control system.

The control system may be any conventional computing system comprising at least one processing units with supporting hardware/software, and may be installed in chassis 3 or pod 2, or partly in chassis 3 and partly in pod 2, or partly or completely cloud based.

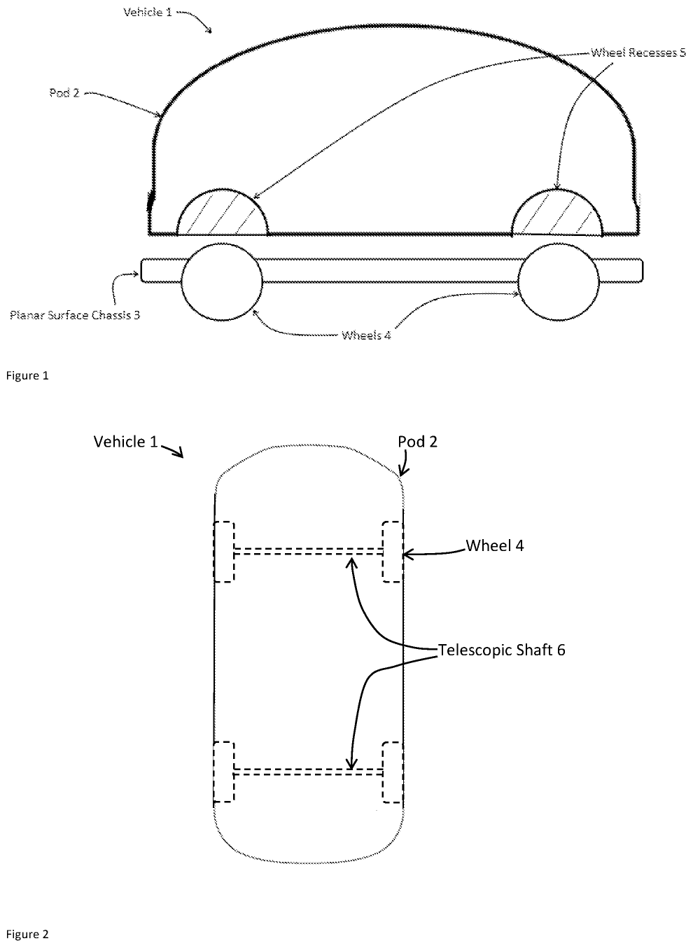

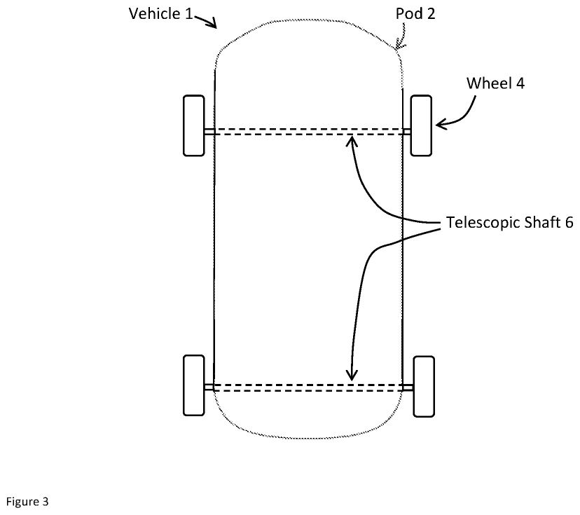

According to a first embodiment and referring to FIGS. 1, 2 and 3, wheels 4 of the present vehicle 1 are each directly or indirectly attached to an end of a telescopic shaft 6.

The telescopic shaft 6 can be extended laterally by a driving device, basing on any conventional mechanical, hydraulic or pressurized fluid techniques, under control of the control system, for pushing the attached wheels 4, with or without other related/associated parts, out of wheel recesses 5 of pod 2, so as to allow pod 2 to be moved longitudinally with respect to chassis 3, on the surface of chassis 3, unhindered by wheels 4, when in a pod transfer operation, or in a hazard escape operation caused by a detection of a hazard, in the above-mentioned manner, under control of the control system. The hazard may be a fire, or a (frontal/rear) collision impact. In case the present vehicle has 2 front wheels 4, and 2 rear wheels 4, on its two sides, then there will be totally 4 wheels 4, for to be moved out of 4 wheel recesses 5.

Those “other related/associated parts”, may be a motor for driving such a wheel 4, or a steering device for changing the driving direction of such a wheel 4, or a part thereof; or a protective structure, such as a shield for enclosing or protecting a part of such a wheel 4.

And, conventional telescopic techniques for varying spacing between two (front or rear) wheels 4, may be used or applied herein, including those as disclosed in U.S. Pat. Nos. 6,199,769 and 9,527,536, as well as China patent application 201911055763.5, and the three documents are incorporated herein by reference, as illustrative, non-limiting examples only.

If a side impact or an imminent side impact is detected by the above-mentioned sensors, the wheels 4 at the side of the present vehicle 1 not facing the side impact, may be moved laterally in the above-mentioned manner, in order to provide some freedom for pod 2 to be moved laterally on the surface of chassis 3, away from the impact, under control of the control system.

The above-mentioned longitudinal and lateral movements of pod 2, on the surface of chassis 3, can be achieved by using “moving mechanisms” as disclosed in the “patent applications”, or other conventional moving mechanism, under control of the control system, and/or caused by an external side impact.

Additionally, when the present vehicle 1 is in normal operations, such as, moving on a road, pod 2 is attached to chassis 3 by the above-mentioned attachment and detachment device.

And, before pod 2 is to be moved by the moving mechanism, the control system causes the attachment and detachment device to detach pod 2 from chassis 3, and the moving mechanism will then become the only mechanical linkage between pod 2 and chassis 3, for causing and also, for preventing relative movement between pod 2 and chassis 3. Note that with the provision of the moving mechanism, the existence of the attachment and detachment device is no longer a must.

Desirably, the mechanical linkage, allows an external impact exceeding, but not less than, a predetermined limit, to cause pod 2 to be moved in relative to chassis 3, even when the mechanical linkage is preventing (or causing) relative movement between pod 2 and chassis 3, so that the damage suffered by pod 2, caused by the impact, can be reduced. For details, pls. refer to mother application Ser. No. 17/578,487.

Desirably, the control system causes a wheel 4 to be moved out of a wheel recess 5, after it determines this movement of wheel 4 will not cause an impact risk to external objects such as humans, vehicles, by the detecting and identifying external objects, as disclosed in US patent U.S. Ser. No. 11/254,272 and PCT International application PCT/IB2021/051670, and the two documents are incorporated herein by reference, as illustrative, non-limiting examples only.

Basing on the determination of the impact risk, the wheels 4 at both sides of the vehicle 1, may be moved to different distances laterally, in order for allowing longitudinal movement of pod 2 in relative to chassis 3, on the surface of chassis 3.

If so, the control system may have to cause pod 2 to be moved laterally on the surface of chassis 3, towards the more outwardly moved wheels 4 at one side of the vehicle 1, so as for moving pod 2, and the wheel recesses 5 thereof, away from the wheels 4 at the other side of the vehicle 1, which are less outwardly moved, or not being moved at all.

And the result will be, all wheels 4 at both sides are out of their wheel recesses 5.

Alternatively, the impact risk may be determined basing on a presumption that no external objects would exist in a position, or very close to a position where the present vehicle 1 which is running on a road, is going to occupy, or has just left.

And accordingly, the control system determines the positions where the present vehicle 1 has been, in a most recent time period, says, 1/20 of a second, and also determines the positions where the present vehicle 1 will be in, in a coming time period, says, 1/20 of a second.

And if it is determined that a wheel 4, if being so laterally moved, will be within those positions of the vehicles, or within a short distance (says, ⅓ meter) from those positions of the vehicle, then the control system will cause the wheel 4 to make the lateral movement.

Note that the above-mentioned time periods and distance may also be dependent on the potential collision risks detected or determined, as will be discussed herein below, and if the potential collision risk(s) is/are low, then the time periods and/or the distance can be longer.

This innovative technique may also be used for extending/moving object out of the present vehicle 1, such as external impact absorbing/resisting devices, and devices for preventing intrusion by another vehicle into the present vehicle 1 when it is not carrying a pod 2, as disclosed in the “patent applications”.

According to a second embodiment, the control system bases on potential collision risks of the present vehicle 1, such as its speed, traffic conditions (for e.g., whether there is high speed moving vehicles nearby), weather conditions, road conditions, vehicle conditions, vehicle component conditions, visibility on the road; to cause the wheels 4 to be moved completely out of wheel recesses 5, so as to permit longitudinal movement of pod 2 with respect to the chassis 3, as a proactive measure against potential severe damages and losses, if a frontal/rear collision suddenly happens.

As a modification, the wheels 4 is only moved partly, not completely, out of wheel recesses 5, so as to reduce the time needed to move them completely out of wheel recesses 5, when a collision or imminent collision is detected, in the manner as mentioned above.

As another modification, the wheels 4 are moved completely out of/into said at least two recesses, if said potential collision risk is at its highest/lowest level corresponding respectively.

And, if the potential collision risk becomes less serious, or no longer exists, for e.g., there is no high speed moving vehicles nearby, the control system will cause the wheels 4 to move partly or completely back into wheel recesses 5.

To achieve these, the control system is capable of detecting and determining the above-mentioned potential collision risks, by use of conventional techniques and sensors. And, U.S. Pat. Nos. 5,809,437 and 7,082,359 disclose such detection techniques, and sensors, and their entire contents are incorporated herein by reference as illustrative, non-limiting examples only.

As a modification, the control system receives user commands to move the wheels 4 to partly or completely out of/back into wheel recesses 5, but if a user command is received for moving the wheels 4 back into wheel recesses 5, the control system may refuse the command, if it detects or determines an above-mentioned potential collision risk exists, or execute the command but issues a warning signal with information of the potential collision risk, to the user.

As an alternative, the above-mentioned sensors and techniques for detecting and/or determining the potential collision risks, are being used by an autonomous vehicle friendly infrastructure (AVFI) installed at roadside, and the control system receives potential collision risk information from the AVFI and uses it in the above-mentioned manner.

According to a third embodiment, an initial backward/forward longitudinal movement of pod 2, caused by a frontal/rear collision impact or other impact directly or indirectly, is being used by a mechanical device to cause wheels 4 to move out of wheel recesses 5, so as to allow further longitudinal movement of pod 2, in relative to chassis 3, on the surface of chassis 3, caused by the impact and/or by the moving mechanism, under control of the control system, in the above-mentioned manner.

Specifically, rack and pinion techniques are used such that the initial longitudinal movement of pod 2 causes a rack to be moved, and which further causes an associated pinion to rotate, and the rotations of the pinion is used as an input of a gear box which is used for changing the rotation speed/force/ratio, and the output rotations of the gear box is used to turn another pinion, for causing another rack to move laterally, and the another rack further pushes a telescopic shaft 6 and its attached wheel 4, out of a wheel recess 5.

As an alternative, the initial backward movement of pod 6 causes a wedge attached to it, to be moved. The wedge has a surface inclined at 45° to the vertical plane passing through the horizontal longitudinal axis of the present vehicle, and the surface is pressing against another surface of another wedge, to force the another wedge to move away.

Thereby, the another wedge which is being attached to an extendable portion of a lateral telescopic shaft 6, is forced to move laterally, and at the same time, pushes the extendable portion, with an attached wheel 4, to move out of a wheel recess 9.

Other conventional mechanical devices and techniques may be alternatively used instead.

As a modification, a conventional locking pin is disposed on the telescopic shaft 6, for preventing its extension, and preventing a wheel 4 attached to its end, from moving out of a wheel recess 5.

And, as in a manner similar to the above-mentioned, the initial movement of pod 6 is converted as a driving force, to move the locking pin, not pod 2, to an unlocking position, and the extension of the telescopic shaft 6 is enabled.

Thereafter, the telescopic shaft 6 is extended by a pressure supplied by a storage of pressurized fluid or the likes, or by spring action, which may be in an automatic manner as the pressure for the extension may be existing before the impact.

Alternatively, the pressure is generated by a conventional electromechanical hydraulic device under control of the control system, when the control system detects the locking pin is being moved to the unlocking position, by the above-mentioned infra-red (IR) emitter and sensor technique used for detecting position of a locking pin of the attachment and detachment device.

Further, a movable element may replace the role of pod 6, for to be moved forward or backward by an impact. The movable element is a lengthy rigid element lying longitudinally in the present vehicle 1, and its forward end is desirably positioned at the foremost part of the vehicle, within a “crush zone” for absorbing a frontal impact by metal deformation, whereas its backward end is desirably located at a position close to the end of pod 2. Note that the movable element should desirably not be deformed by any impact.

The chassis and/or the pod may provide a lengthy hole for accommodating the movable element.

Note that the forward or backward movement of pod 6 or the movable element, may be enabled by the control system by causing the attachment and detachment device to detach pod 2 from chassis 3, or caused by the control system by using a moving mechanism, in the above-mentioned manner, or a similar manner, but such movements of pod 6 or the movable element may also be caused by an impact forcibly and unexpectedly.

According to a fourth embodiment, the above-mentioned attachment and detachment device, driving device of the telescopic shafts 6, and moving mechanism of pod 2, are under control of different processing units. This may happen in situations such as the two devices and one mechanism come from different suppliers, and further, they may be capable of receiving user commands from different users, for controlling their individual operations, such as in a pod transfer.

In operation, when the processing unit of the moving mechanism is going to cause the moving mechanism to move pod 2 in relative to chassis 3, it will first check if the attachment and detachment device has detached pod 2 from chassis 3, and the driving device has extended telescopic shafts 6 such that their attached wheels 4 are being moved out of wheel recesses 5, by communicating with the other processing unit(s), and the other processing unit(s) will send information to the processing unit of the moving mechanism, to indicate whether the other processing unit(s) has caused the attachment and detachment device to detach pod 2 from chassis 3, and whether the other processing unit(s) has caused the driving device to extend telescopic shafts 6 such that their attached wheels 4 are being moved out of their wheel recesses 5.

Alternatively, the processing unit of the moving mechanism determines i) if the attachment and detachment device has detached pod 2 from chassis 3, by use of the above-mentioned infra-red (IR) emitter and sensor to determine if the locking pin of the attachment and detachment device is in an unlocking position; and ii) if the positions of wheels 4 are out of their wheel recesses 5, by conventional position determining techniques directly or indirectly, including those as disclosed in U.S. Pat. U.S. Ser. No. 10/634,761B2, PCT Pat. Appl. WO2010150148A1, U.S. Pat. Appl. US2012244881A1 and U.S. Pat. Appl. U.S. Pat. No. 4,576,481A, and their contents are incorporated herein by reference, as illustrative, non-limiting examples only.

Finally, the processing unit of the moving mechanism controls the moving mechanism to move pod 2 in relative to chassis 3, if pod 2 is detached from chassis 3, and wheels 4 are being moved out of their wheel recesses 5, for allowing relative movement between pod 2 and chassis 3.

According to a fifth embodiment, the control system determines if the present vehicle 1 is carrying pod 2, by means of a pressure sensor for sensing the weight of pod 2, disposed in the chassis 3 of the present vehicle 1, and for sending to the control system signals indicative of the presence or absence of pod 2.

If pod 2 is not there, then the control system will cause an intrusion prevention device, to be activated and to move/extend to a predetermined position.

The determination of the presence or absence of pod 2 may be unnecessary if the control system itself causes pod 2 to move out of the present vehicle 1, in the above-mentioned manner. Other conventional determination techniques may also be used instead.

Further, the control system has sensors which may be a conventional movement/position detector for determining if the intrusion prevention device is functioning normally, by directly or indirectly detecting if the intrusion prevention device, or a part thereof, has moved/extended to the predetermined position.

For one instance, the movement/position sensor may be a camera with artificial intelligent as a support to process image signal for recognizing images, so as to detect the physical position of the intrusion prevention device, or a part thereof. The camera may also be used to determine the presence or absence of pod 2, in the same manner.

For another instance, an electromechanical lock can be used for locking the intrusion prevention device, or a part thereof, when it has moved or extended to the predetermined position, so as to prevent it from moving or retracting back to its original position, and for sending a signal to the control system indicating whether the device is successfully locked or not. The above-mentioned IR emitter and receiver for detecting the position of the locking pin of the attachment and detachment device, may be applied here for determining if the locking of the intrusion prevention device is successful.

Alternatively, by visual inspection, a human operator (who may be a driver of the present vehicle 1), can know if the intrusion prevention device, or a part thereof, has moved/extended to the predetermined position, and the operator may move/extend the device into the predetermined position himself, or control a machine arm or the likes, to do so.

And, an input device associated with the control system, may be used for receiving input from a human operator for indicating the intrusion prevention device is functioning normally or not, or in other words, has moved/extended to the predetermined position or not, and the control system maintains a record of the input and identity of the operator, so that other operator may know from the record who determined whether the intrusion prevention device was functioning normally or not, and should be held responsibility.

If the intrusion prevention device is determined as not functioning normally, the control system disables itself from receiving any request for driving the present vehicle. Alternatively, the control system may allow the vehicle to be driven, autonomously or by a human driver, at a speed, which is lower than a permissible speed when the intrusion prevention device is determined as functioning normally, and may be for a limited time and/or for a limited distance, for e.g., allow the vehicle to go to a nearby parking site or repair center.

The control system will also issue a warning signal to request for a repair, and/or to alert other nearby vehicles of any possible risk, such as the present vehicle has an oil tank or battery pack on the chassis bottom, and an intrusion may cause an explosion.

It should be noted that the above embodiments/examples/modifications/alternatives are given by way of examples only, and it will be obvious to those skilled in the art that various changes and modifications on any one or any combination of them, may be made without departing from the spirit of the present invention.

1. An apparatus for use on a vehicle, said vehicle including a main body and a sub-body, and when said vehicle being in normal operation such as moving on a road, said sub-body is being laid on said main body;
wherein at least one recess of said sub-body, is being disposed on lateral side(s) of said sub-body, for accommodating a portion of corresponding respective at least one road-running wheel of said vehicle, and as a result, said at least one road-running wheel constituting a hindrance to longitudinal and/or lateral movement of said sub-body in relative to said main body;
wherein said apparatus comprising:
a sub-body positioning system configured to carry out an operation to allow and also, an operation to prevent said relative movement between said sub-body and said main body;
a wheel-moving device configured to carry out an operation to cause said at least one road-running wheel to move out of said at least one recess, telescopically and/or retractably, and thereby, allowing said relative movement;
wherein said operation of said sub-body positioning system for allowing said relative movement, being associated with said operation of said wheel-moving device for allowing said relative movement, so as to achieve both said sub-body positioning system and said wheel-moving device allowing said relative movement, in a same time period.

2. An apparatus as claimed in claim 1, wherein at least one of two wheels of said at least one road-running wheel at two opposite sides of said vehicle are being moved outward from their recesses in said sub-body, by said wheel-moving device, and said sub-body positioning system also being configured to, cause said sub-body to be moved toward one of said two wheels which is being moved more outward by said wheel-moving device, in order that said two wheels are both out of their said recesses completely, so as to allow said relative movement of said sub-body;
wherein another one of said two wheels being not moved at all, or being not moved out of its recess completely, by said wheel-moving device.

3. An apparatus as claimed in claim 1, wherein said operations of said sub-body positioning system and said wheel-moving device, both for allowing said relative movement, being associated, during a transfer of a sub-body into/from said vehicle from/into a platform.

4. An apparatus as claimed in claim 3, wherein further comprising a moving device for moving said sub-body in relative to said main body, under control of a controlling system;
wherein said operations of said wheel-moving device and said sub-body positioning system, both for allowing said relative movement, being under control of other controlling system(s);
wherein before causing said moving device to move said sub-body, said controlling system determining whether said other controlling system(s) has caused both said sub-body positioning system and said wheel-moving device to allow said relative movement, and if said relative movement being so allowed, said controlling system causing said moving device to move said sub-body in relative to said main body, and not causing if otherwise, and in this way, said operations of said sub-body positioning system and said wheel-moving device, both for allowing said relative movement, being associated.

5. An apparatus as claimed in claim 4, wherein said controlling system determining whether said other controlling system(s) having caused both said sub-body positioning system and said wheel-moving device to allow said relative movement, by obtaining related information from said other controlling system(s); or alternatively, said controlling system determining if a locking element of said sub-body positioning system being in an unlocking position for detaching said sub-body from said main body, and if position of said at least one road-running wheel being out of said at least one recess.

6. An apparatus as claimed in claim 1, wherein further comprising:
a controlling system;
a detection system configured to, under control of said controlling system, detect a collision or an imminent collision involving said vehicle, and to provide related collision information;
wherein said controlling system causing both said sub-body positioning system and said wheel-moving device to allow said relative movement, in response to said collision information directly or indirectly.

7. An apparatus for enhancing safety of a vehicle, said vehicle including a main body and a sub-body, and when said vehicle being in a normal situation such as moving on a road, said sub-body is being laid on said main body;
wherein at least one recess of said sub-body, is being disposed on lateral side(s) of said sub-body, for accommodating a portion of corresponding respective at least one road-running wheel of said vehicle, and as a result, said at least one road-running wheel constituting a hindrance to longitudinal movement of said sub-body in relative to said main body;
wherein said apparatus comprising:
a movable device for to be caused to make a movement by a collision impact on said vehicle directly or indirectly;
a mechanical device for mechanically converting said movement of said movable device, into an actuation to directly or indirectly cause said at least one road-running wheel to be moved out of said at least one recess, telescopically and/or retractably, so as to remove said hindrance.

8. An apparatus as claimed in claim 7, wherein said movable device being said sub-body;
wherein further comprising a detaching system;
wherein said movement taking place after said detaching system having detached said sub-body from said main body; or alternatively, said sub-body being forcibly detached from said main body by said collision impact.

9. An apparatus as claimed in claim 7, wherein further comprising:
a locking device configured to lock said at least one road-running wheel inside said at least one recess directly or indirectly;
wherein said actuation being for causing directly or indirectly said locking device to be moved to an unlocking position, so as to allow said at least one road-running wheel to be moved out of said at least one recess;
wherein said movable device being said sub-body, or a movable part.

10. An apparatus as claimed in claim 9, wherein further comprising:
a device configured to move said at least one road-running wheel out of said at least one recess, in response to or after said locking device being moved to said unlocking position, so as to allow longitudinal movement of said sub-body in relative to said main body.

11. An apparatus for use on a vehicle, said vehicle including a main body and a sub-body, and when said vehicle being in normal operation such as moving on a road, said sub-body is being laid on said main body;
wherein at least two recesses of said sub-body, are being disposed on both lateral sides of said sub-body, for accommodating a portion of corresponding respective at least two road-running wheels of said vehicle, and as a result, said at least two road-running wheels constituting a hindrance to longitudinal movement of said sub-body in relative to said main body;
wherein said apparatus comprising:
a controlling system;
a potential collision risk system configured to detect, determine or obtain information related to potential collision risk of said vehicle;
a wheel-moving device configured to, under control of said controlling system, cause said at least two road-running wheels to be moved partly or completely out of said at least two recesses, for reducing or removing said hindrance, according to said information;
a detection system configured to, under control of said controlling system, detect a frontal collision or an imminent frontal collision of said vehicle, and generate a related collision signal;
wherein said controlling system causing said wheel-moving device to move said at least two road-running wheels completely out of said at least two recesses, in response to said collision signal;
wherein said wheel-moving device moving said at least two road-running wheels outward of or backward into said at least two recesses, if said potential collision risk being corresponding respectively high or low, for corresponding respectively reducing or restoring, a response time to a frontal collision or an imminent frontal collision as detected by said detection system;
wherein said response time being time needed for moving said at least two road-running wheels completely out of said at least two recesses, by said wheel-moving device, and said frontal collision may or may not happen.

12. An apparatus as claimed in claim 11, wherein said wheel-moving device causing said at least two road-running wheels to be moved completely out of/into said at least two recesses, if said potential collision risk being at a highest/lowest level corresponding respectively.

13. An apparatus as claimed in claim 11, wherein further comprising:
a module configured to receive a user command;
wherein said controlling system also being configured to be caused by said command, to cause said wheel-moving device to move said at least two road-running wheels out of or back into said at least two recesses, for corresponding respectively reducing or restoring, said response time.

14. An apparatus as claimed in claim 11, wherein further comprising:
a moving system, under control of said controlling system, configured to move said sub-body in relative to said main body;
wherein at least one of two wheels of said at least two road-running wheels at two opposite sides of said vehicle are being moved outward from their recesses in said sub-body, by said wheel-moving device, under control of said controlling system, and said moving system, under control of said controlling system, causing said sub-body to be moved toward one of said two wheels which is being moved more outward by said wheel-moving device, in order that said two wheels are both out of their said recesses completely;
wherein another one of said two wheels being not moved at all, or being not moved out of its recess completely by said wheel-moving device.
